(19) United States
(12) Patent Application Publication
(10) Pub. No.: US 2008/0164970 A1
(43) Pub. Date: Jul. 10, 2008

(54) Contactless Magnetic Potentiometer

(75) Inventor: Heinz Herbert Malzahn, Essen (DE)

Correspondence Address: KIRTON AND MCCONKIE, 60 EAST SOUTH TEMPLE,, SUITE 1800, SALT LAKE CITY, UT, 84111, US

(73) Assignee: SPECTRA SYMBOL CORP., Salt Lake City, UT (US)

(21) Appl. No.: 11/994,069

(22) PCT Filed: Jun. 29, 2006
(86) PCT No.: PCT/US2006/025481

§ 371 Date: Dec. 27, 2007

(30) Foreign Application Priority Data
Jun. 30, 2005 (DE) 20 2005 010 424.8

(51) Int. Cl. H01C 10/30; H01C 17/00

(52) U.S. Cl. 338/160; 29/610.1

(57) ABSTRACT

A contactless potentiometer is described wherein the conductive and resistive traces of the potentiometer are contained within a sealed channel formed of non-conductive material. The electrical gap between the conductive and resistive traces is bridged by a magnetically reactive contactless tap. A magnetic force is applied to the tap through the surface of the channel holding the conductive and resistive traces. This provides a drawing magnetic force to the tap which pulls the tap against the traces and allows for changing the resistance of the potentiometer by laterally moving the tap along the traces as the tap moves to follow the motion of the external force.

### CROSS-REFERENCE TO RELATED APPLICATIONS

This application claims priority to patent application number 20 2005 010 424.8 filed in the German Patent and Trademark Office on Jun. 29, 2005.

### BACKGROUND OF THE INVENTION

1. Field of the Invention

The present invention relates to a tap for potentiometers, and more particularly to a contactless tap for resistive surfaces by means of magnets.

2. Background and Related Art

Film potentiometers on the market operate with an actuating pressure on the tapping pressure pin. Over time, the actuating pressure on the tapping pressure pin strips the upper plastic film on the resistive path, causing the film to wear out. As the plastic film on the resistive path wears out, the resistive path may become increasingly pre-formed and as a result the top layer can pre-actuate electrically, or the contact wiper can physically tear the top layer. This decreases the life of the film potentiometers and can result in locations of lost contact.

Existing film potentiometers also require a parallel guidance of the tapping pressure pin. This increases manufacturing costs as relatively large additional structure must be provided to support and provide the guidance of the tapping pressure pin.

### BRIEF SUMMARY OF THE INVENTION

A potentiometer is described wherein the conductive and resistive traces of the potentiometer are contained within a sealed channel formed of non-conductive material. The gap between the conductive and resistive traces is bridged by a tap formed from a conductive permanent magnet or by a conductive ferromagnetic material. A magnetic force may be applied to the tap through the surface of the sealed channel by means of a magnet located outside the sealed channel. This pulls the tap against the traces to make electrical contact between the traces. This allows for changing the resistance of the potentiometer by moving the tap along the traces within the sealed channel, as the tap moves according to the magnetic force exerted from without the sealed channel. The force exerted on the tap may be modified by changing the characteristics of the external magnetic force.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a perspective view of one embodiment of the invention that comprises a backing and paths;

FIG. 2 shows a perspective view of the embodiment of FIG. 1 with a spacer added;

FIG. 3 shows a perspective view of a tap for use with the embodiment of FIGS. 1 and 2;

FIG. 4 shows a perspective view of the embodiment of FIGS. 1-3 with a cover added.

FIG. 5 shows an inverted perspective view of the embodiment of FIG. 4 with an external control element added.

FIG. 6 shows a cross-sectional view of the embodiment of FIG. 5.

FIG. 7 shows a view of an embodiment having a non-linear shape.

FIG. 8 shows a view of an embodiment having an arc-like shape.

FIG. 9a shows a view of an embodiment having a semi-circular shape.

FIG. 9b shows a view of an embodiment having a circular shape.

FIG. 10a shows a view of an embodiment having a non-linear shape.

FIG. 10b shows a view of an embodiment having a non-linear shape.

### DETAILED DESCRIPTION OF THE INVENTION

Referring now to the figures, a description of some embodiments of the present invention will be given. It is expected that the present invention may take many other forms and shapes, hence the following disclosure is intended to be illustrative and not limiting, and the scope of the invention should be determined by reference to the appended claims.

In some embodiments, the invention comprises a sealed channel containing conductive and resistive traces; a tap comprised of one or more materials that are measurably subject to magnetic forces; and an external control element that is measurably subject to magnetic forces. In some embodiments, a permanent magnet or an electromagnet is used as either the tap or the external control element. In some embodiments, because the channel is sealed, there is no physical contact between the tap and the external control element during operation of the invention.

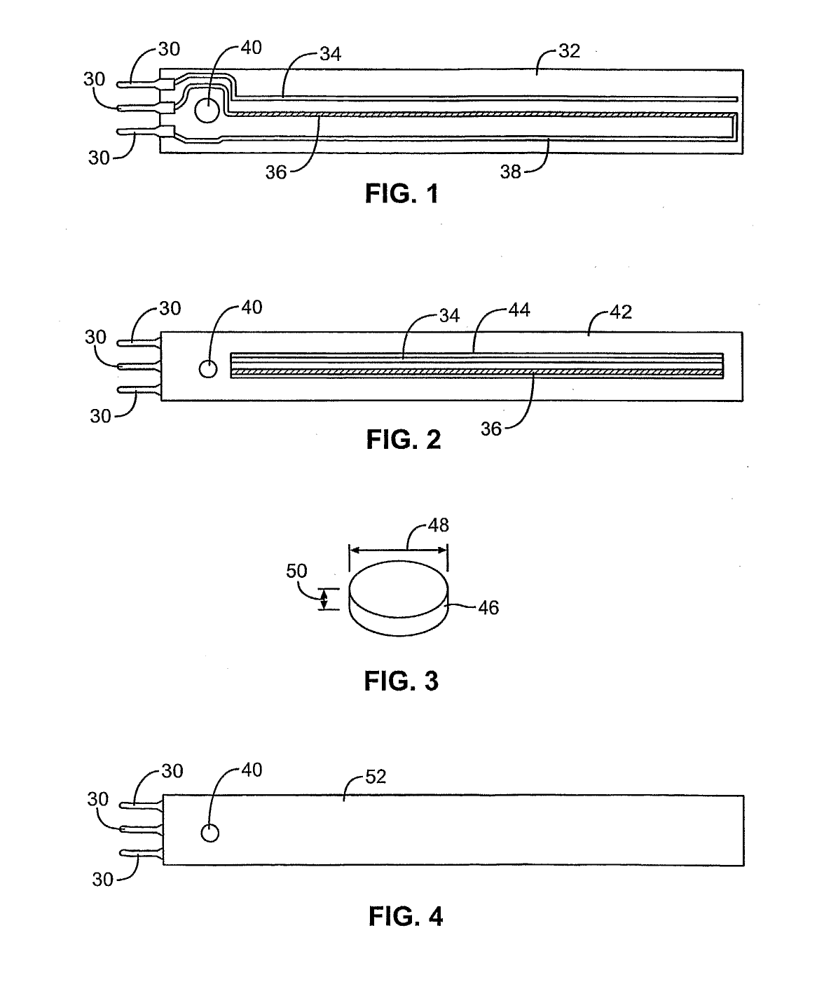

FIGS. 1 through 4 illustrate the components of one embodiment of the invention comprising a linear slide potentiometer having three connection terminals 30, as is well-known in the art of potentiometers. The terminals 30 facilitate making connections with the potentiometer for electrical circuits, as is known in the art. Each of the terminals 30 may be physically and electrically connected to one of three paths on a non-conductive backing 32. The backing 32 may be relatively thin and non-conductive, and may be made of a non-magnetic heat-resistive material such as epoxy or various types of plastic. The overall length of the potentiometer shown in FIGS. 1 through 4 as well as the lengths of the exemplary paths may be varied to suit the needs of the specific application in which the potentiometer will be used.

In FIG. 1, the topmost terminal 30 is connected to a conductive path 34 that may be a conductive film path made from any number of conductive materials. As non-limiting examples, the conductive path 34 may be made of silver, gold, copper, or aluminum. The conductive path 34 is attached to the backing 32 by any means known in the art, or it may be originally deposited on the backing 32 during manufacture of the backing 32. In FIG. 1, the lower two terminals 30 are connected in an electronic loop that passes through a resistive path 36 and a conductive path 38 in series. The conductive path 38 may be of a different width or thickness than conductive path 34. All of the paths 34, 36, and 38 may be placed on the top surface of the backing 32 so as to be electrically insulated from the bottom surface of the backing 32, and available to electrical contact from above the backing 32. In some configurations, one or more of the paths may be configured to lie in different planes from one another, according to manufacturing or design requirements.

Although FIG. 1 shows each of the terminals 30 exiting from one side of the potentiometer, the layout shown in FIG. 1 may be varied to place the location of the terminals 30 at different positions than shown. For example, the topmost or bottommost terminals 30 might optionally be placed on the right and connected to the conductive paths 34 and 38 respectively. Because the conductive paths 34 and 38 are conductive, this change in terminal location would have no electrical effect. These types of variations are known in the art to facilitate connection of the potentiometer in whatever way is most useful for the particular application, and are embraced by the invention. The various paths 34, 36, 38 may be routed around mounting hole 40 or any variety of other shape configurations of backing 32 in order to allow the potentiometer to be fixedly mounted within an electrical application.

The resistive path 36 may be formed by any number of materials and processes known in the art of forming such resistive paths. The resistive path 36 may be of a thickness similar to conductive path 34 to facilitate contact between the resistive path 36 and the connecting tap (not shown in FIG. 1) and between the conductive path 34 and the connecting tap (not shown in FIG. 1). In one embodiment, the resistive path 36 may be made of a special conductive resistor that is laid down on the backing 32, as is commonly used for slide or linear potentiometers.

FIG. 2 shows the same embodiment as FIG. 1 but with the addition of a non-conductive spacer 42 that has been placed on top of the backing 32 and attached to the backing 32. The spacer 42 may be constructed of any material that does not provide an electrical connection between terminals 30 and paths 34, 36, and 38. Non-limiting examples of such materials include ceramics and many types of plastics. Further, the method of attaching spacer 42 to backing 32 may be done by any method that does not provide any electrical connections between the terminals 30 and paths 34, 36, 38. Non-limiting methods that may be used to attach spacer 42 to backing 32 include gluing and laminating.

The spacer 42 may comprise a cut-out or window 44 that leaves the conductive path 34 and the resistive path 36 uncovered or exposed over at least a portion of their length, while at the same time sealing the perimeter of the part to the entry of foreign particles or environmental contaminants. In this manner, the spacer 42 forms a trough or channel in which the tap (not shown in FIG. 2) for the potentiometer may move to provide an electrical contact between the conductive path 34 and the resistive path 36. Then, as is known in the art, the resistance between the topmost terminal 30 and either of the two lower terminals 30 may be varied by moving the tap (not shown) laterally within the channel formed by the window 44.

FIG. 3 shows a perspective view of one embodiment of a tap 46 for use with the embodiment of the potentiometer shown in FIGS. 1 and 2. In this embodiment, the tap 46 may be contactless, in that movement of the tap is controlled or caused by an element that is not in physical contact with the tap. The tap 46 may be formed out of either an electrically-conductive permanent magnet or an electrically-conductive ferromagnetic material that will react to an externally-applied magnetic force. In one embodiment, tap 46 comprises a neodymium-iron-boron NdFeB or other “rare-earth” magnet. The diameter 48 of the tap 46 may be chosen so as to be small enough that the tap 46 fits within the channel formed by the window 44 of the spacer 42 but also so as to be large enough to contact both the conductive path 34 and the resistive path 36 even when the tap 46 is contacting any side of the window 44 while in the channel. The thickness 50 of the tap is chosen so as to be thinner than the thickness of the spacer 42 so as to allow free non-frictionally-impaired movement of the tap within the channel after a non-conductive cover is placed over the channel, as described hereinafter.

In use, the tap 46 is placed within the channel or trough formed by the window 44. If the orientation of the externally-applied magnetic field to control the tap 46 will be important and if the tap 46 is a permanent magnet, the orientation of the tap 46 is chosen so as to properly interact with the externally-applied magnetic field, as will be appreciated by one skilled in the art from the following description of use of the tap 46 in the potentiometer. After the tap 46 is placed in the channel, a non-conductive cover 52 is placed over the window 44 and attached to the spacer 46 in a fashion similar to the attachment of the spacer 46 to the backing 32. (See FIG. 4.) The cover 52 may be made of any non-conductive material, and may be formed of a material similar to the material used for the backing 32 or the material used for spacer 46. In this embodiment, the cover 52 seals the window 44, preventing the intrusion of dirt or other environmental contaminants on to paths 34 and 36, and thus increasing the useful life of the potentiometer.

In the embodiment shown in FIGS. 1-4, the body of the potentiometer is thus formed by backing 32, spacer 46, and cover 52, which together comprise a sealed channel in which tap 46 is contained. FIG. 6 shows a cut-away view of backing 32, spacer 42, and cover 52, with tap 46 and traces 34 and 36 visible (in addition to other elements of one embodiment to be discussed below).

In other embodiments, a sealed channel may be formed from a unitary piece of material into which traces and a tap are added, or from a smaller or larger number of individual components formed to create a sealed channel containing traces and a tap. In some embodiments, the materials used to create a sealed channel comprise transparent or semi-transparent materials that permit viewing of the tap; in some embodiments, the materials used to create a sealed channel are substantially opaque. Different portions of the sealed channel or the components thereof may have varying opacity as required by a specific application. The sealed channel may further comprise flexible materials or materials that resist flexure. The heat-resistant properties and durability of the materials comprising the sealed channel may be selected based on the requirements of a specific application by one skilled in the art.

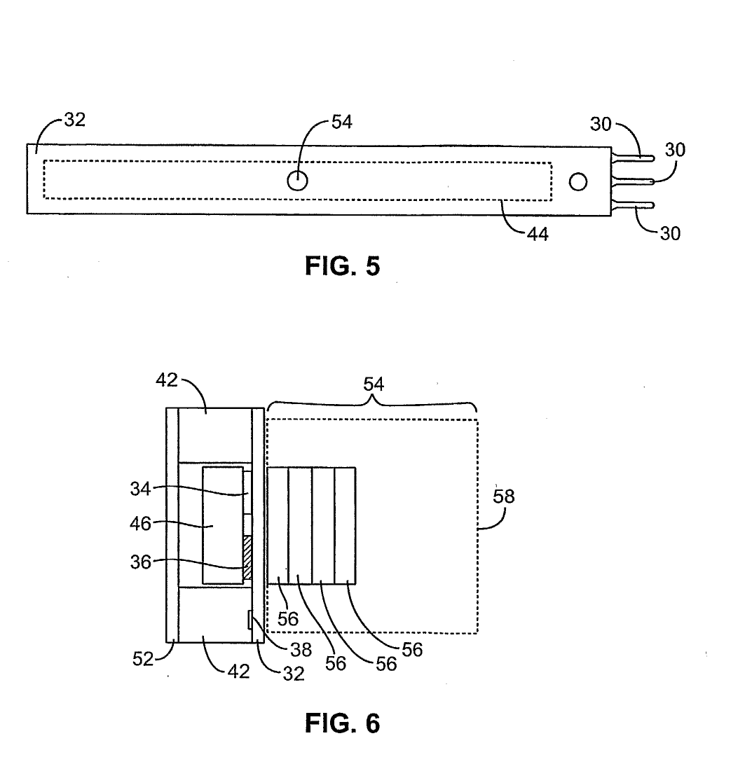

In some embodiments, the bottom surface of the backing 32 is in contact with the external control element during use of the potentiometer, such that the external control element biases the tap against the paths 34 and 36 to create an electrical connection. In such an embodiment, the cover 52 may become the surface of the potentiometer that may be attached to the device with which the potentiometer is to be used. FIG. 5 shows such an inverted potentiometer with the bottom surface of the backing 32 exposed, and the window 44 shown in outline form. Paths 34 and 36 are not shown in FIG. 5. An external control element 54 is shown in FIG. 5, positioned so as to affect the position of the tap 46 within the sealed channel. In FIG. 5, tap 46 is positioned directly under external control element 54, into the page in this view. The external control element 54 magnetically interacts with the tap 46 and, via the magnetic force existing between the external control element 54 and the tap 46, pulls the tap 46 against the conductive path 34 and the resistive path 36 so as to electrically connect the conductive path 34 and the resistive path 36 at the location of the external control element 54. In this embodiment, this magnetic interaction simultaneously secures the external control element 54 to the potentiometer, obviating the need for an external structure to guide the path of the external control element 54. In some embodiments, the external control element 54 does not physically contact the sealed channel, but moves within an external structure that permits magnetic interaction with the tap 46. In this manner, the forces exerted on the paths 34 and 36 and on the materials comprising the sealed channel are minimized.

Because the only contact between the external control element 54 and the tap 46 is magnetic, the force applied to the conductive path 34 and the resistive path 36 is constant and unaffected by most external forces applied to the external control element 54. For example, if the user of the potentiometer applies a downward force (into the plane of FIG. 5) to the external control element 54, that force has no effect on the force between the tap 46 and the conductive path 34 and the resistive path 36. This prevents externally-applied forces from causing damage to the thin films or traces forming the various paths 34, 36. If an external force causes the external control element 54 to move laterally so as to be outside the area defined by the window 44, the magnetic interaction between the external control element 54 and the tap 46 may simply fade. In some embodiments, the external control element 54 can thus be removed, and if the removal was accidental, the external control element 54 may simply be placed along the backing 32 so as to be over the window 44 and then moved about until it interacts with the tap 46 again. If desired, an external structure corresponding to the window 44 may be provided so as to prevent accidental movements of the external control element 54 beyond the area defined by the window 44.

The present invention not only provides for a constant force between the tap 46 and the conductive path 34 and the resistive path 36, but also provides a means for precision control of the force applied to those paths 34 and 36 by the tap 46. This may be appreciated by reference to FIG. 6. FIG. 6 is a cross-sectional view of the body of the potentiometer and one embodiment of the external control element 54. This cross-sectional view clearly shows the interaction of the various members of the body of the potentiometer: the backing 32, the spacer 42, and the cover 52. FIG. 6 also shows how the conductive path 38 is sandwiched between the spacer 42 and the backing 32, and hence the exact dimensions of the conductive path 38 are of lesser importance than the dimensions of the conductive path 34 and the resistive path 36.

FIG. 6 also illustrates the interaction of the tap 46 with the external control element 54. In one embodiment, the external control element 54 includes one or more permanent magnets 56. The permanent magnet or magnets 56 are positioned and oriented so as to attractively interact with the tap 46. This draws the tap 46 against the conductive path 34 and the resistive path 36 so as to form an electrically-conductive bridge between those paths 34, 36. As the external magnets 56 of the external control element 54 are moved laterally (in and out of the plane of FIG. 6), they draw the tap 46 along the paths 34 and 36 so as to vary the resistance of the potentiometer and provide the potentiometer's functions. The force that the tap 46 applies to the conductive path 34 and the resistive path 36 may be varied by varying the number of permanent magnets 56 in the external control element 54. In FIG. 6, four permanent magnets 56 are shown as being used.

In some embodiments, the tap 46 may comprise a magnet and the external control element may comprise a ferromagnetic material; in some embodiments, the external control element may comprise an electromagnet.

The movement of the external control element 54 may be facilitated by providing an optional housing 58 (shown in outline form in FIG. 6) that contains the external control element (permanent magnet(s) 56 in this embodiment) and thus provides a larger surface or structure to facilitate movement. The housing 58 may also be configured to interact with an external structure that keeps the housing 58 in contact with the body of the potentiometer and keeps the housing 58 aligned with the window 44. The housing 58 may also provide an additional method for controlling the magnetic force applied to the tap 46. The housing 58 may be provided with a mechanism to vary the distance of the external control element 54 from the backing 32 and thus the body of the potentiometer. Because magnetic force decreases with distance, the force is varied and controlled by varying the distance of the permanent magnet(s) 56. In one embodiment, this may be accomplished by attaching the magnet(s) 56 to a screw or nut mechanism, the mechanism screwing in and out of the housing 58. Alternatively, several housings may be provided that hold the magnet(s) 56 different distances from the body of the potentiometer.

If the tap 46 is a permanent magnet, the permanent magnet(s) 56 may be oriented so as to provide an attractive force on the tap 46. If the tap 46 is a ferromagnetic material, the orientation of the permanent magnets 56 does not matter. Alternatively, if the tap 46 is a magnet, the permanent magnets 56 may be replaced with a ferromagnetic material. The magnetic force is then provided primarily by the tap 46.

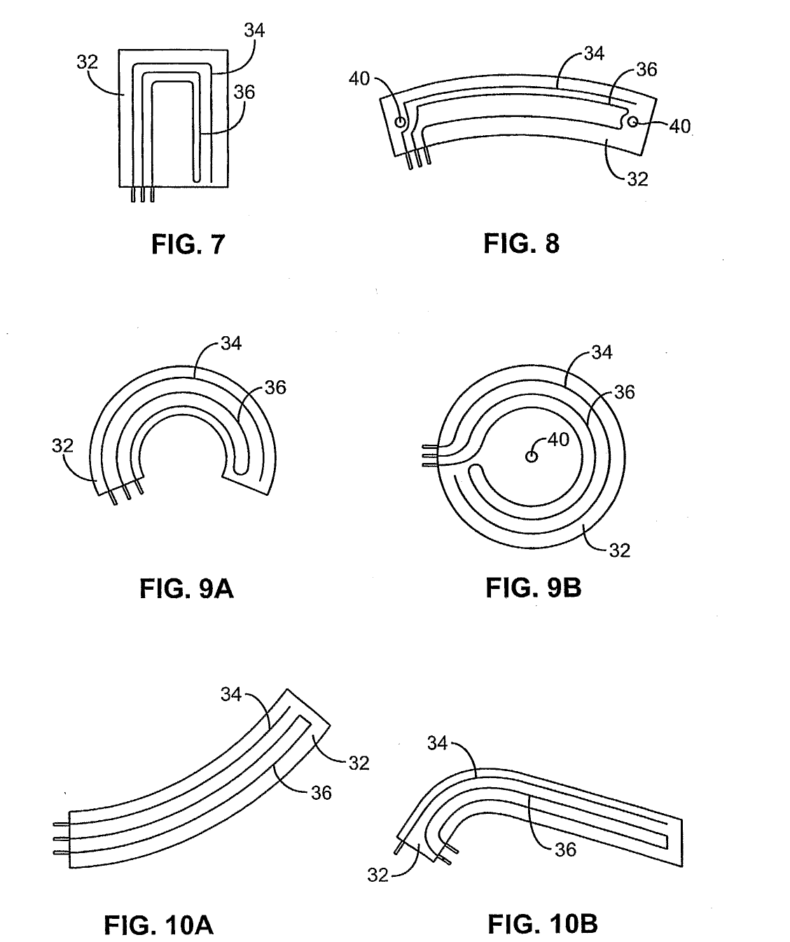

The present invention may assume many other forms. For example, while the illustrated potentiometer is linear, many other shapes could be used as desired. FIGS. 7, 8, 9, and 10 illustrate some of the many possible shapes of embodiments of the present invention. The illustrations in FIGS. 7-10 are not intended to illustrate any scale relative to one another or to limit the possible sizes or configurations of the invention, as the dimensions and characteristics of an embodiment may be modified, as described herein, according to a particular application as is known in the art.

Further, the resistive characteristics of the resistive path within the sealed channel may be varied as is known in the art to create a variable resistance profile that suits a particular application. For example, the potentiometer may have a linear or logarithmic resistance profile.

In some embodiments, the sealed channel in which the tap is contained is configured to move or be moved by a user or by a device with which the potentiometer is intended to operate, while the contactless tap within the sealed channel remains substantially stationary.

In some embodiments, a discrete external control element is not used. Instead, in some embodiments, the tap within the sealed channel responds to a magnetic force originating with one or more devices with which the potentiometer is intended to interact, such as an electric motor or similar electric device; a speaker; or another electric or electronic device generating or having a magnetic field or magnetic force capable of interacting with the tap of an embodiment of the present invention.

Various embodiments of the present invention may be used in a multitude of applications, including both applications where potentiometers are currently used and could benefit from the advantages of the present invention, and also applications where potentiometers are not presently used but where a potentiometer having the characteristics of the present invention may make such use feasible or desirable. Non-limiting examples of applications of embodiments of the present invention include a liquid level sensor; a sensor of linear, non-linear, or rotary motion; or a traditional adjustable switch. Such applications may be found in industrial applications where environmental contaminants make the use of traditional potentiometers problematic, such as use as a sensor in food or chemical processing operations; in consumer goods such as appliances, including washing machines and refrigerators; in automotive products; and in many others.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A potentiometer comprising:
a sealed channel comprising
a conductive path;
a resistive path;
a non-conductive space between the conductive path and the resistive path; and
an electrically-conductive magnetically reactive contactless tap capable of moving within the sealed channel along a portion of the resistive path and capable of bridging the space between the conductive path and the resistive path by simultaneously making contact with the conductive path and the resistive path.

2. The potentiometer of claim 1 further comprising an external control element positioned substantially adjacent the contactless tap and capable of magnetically interacting with the contactless tap so as to cause movement of the contactless tap.

3. The potentiometer of claim 1 wherein the sealed channel further comprises:
a backing;
a non-conductive spacer attached to the backing, the spacer including a cutout area forming a window, the window sized to receive the contactless tap and to provide a sufficient cavity to permit the tap to move through substantially the length of the conductive path and the resistive path; and
a non-conductive cover attached to the spacer to seal the area defined by the backing, the spacer, and the cover with the contactless tap therein.

4. The potentiometer of claim 1 wherein the contactless tap comprises a permanent magnet.

5. The potentiometer of claim 2 wherein the external control element comprises a permanent magnet.

6. The potentiometer of claim 5 wherein the external control element is adjustable to permit variation of the magnetic interaction.

7. The potentiometer of claim 1 wherein the resistive path comprises an electrically resistive trace.

8. The potentiometer of claim 1 wherein the conductive path comprises trace selected from the group consisting of silver, gold, copper, and aluminum.

9. The potentiometer of claim 2 wherein both the contactless tap and the external control element comprise permanent magnets oriented to provide an attractive force between the contactless tap and the external control element.

10. The potentiometer of claim 1 further comprising a first terminal electrically connected to the conductive path and a second terminal electrically connected to the resistive path, wherein the electrical resistance between the first terminal and the second terminal may be varied by changing the position of the contactless tap along the path length of the resistive path.

11. The potentiometer of claim 1 wherein the resistive path has a shape selected from the group consisting of a line, an arc, a semi-circle, a circle, a bent line, and a collection of attached lines.

12. A contactless potentiometer comprising:
a non-conductive backing comprising a top surface and a bottom surface;
a conductive path attached to the top surface of the backing and electrically connected to a first potentiometer terminal, the conductive path having a first path length;
a resistive path attached to the top surface of the backing and running substantially parallel to the conductive path, the resistive path electrically connected on one end of the resistive path to a second potentiometer terminal, the resistive path having a second path length;
a non-conductive space between the conductive path and the resistive path;
an electrically-conductive, magnetically reactive contactless tap sized to bridge the non-conductive space between the conductive path and the resistive path by simultaneously making contact with the conductive path and the resistive path;
a non-conductive heat-resistant spacer attached to the backing, the spacer including a cutout area forming a window, the window sized to receive the contactless tap and to provide a sufficient cavity to permit the contactless tap to move through substantially the length of the conductive path and the resistive path; and
a non-conductive heat-resistant cover attached to the spacer to seal the area defined by the backing, the spacer, and the cover with the contactless tap therein.

13. The potentiometer of claim 12 further comprising an external control element positioned near the bottom surface of the backing opposite the contactless tap, wherein at least one of the contactless tap and the external control element is capable of exerting a magnetic force and wherein the contactless tap and the external control element are attracted together by the magnetic force.

14. The potentiometer of claim 12 wherein the contactless tap comprises a permanent magnet.

15. The potentiometer of claim 13 wherein the external control element comprises a permanent magnet.

16. The potentiometer of claim 12 wherein the electrical resistance between the first potentiometer terminal and the second potentiometer terminal may be varied by changing the position of the contactless tap along the first path length or the second path length.

17. A method of making a contactless potentiometer comprising:
providing a conductive path;
providing a resistive path;
providing a non-conductive space between the conductive path and the resistive path;
providing a sealed channel containing the conductive path and the resistive path; and
providing an electrically-conductive contactless tap capable of moving within the sealed channel along a portion of the resistive path and capable of bridging the non-conductive space between the conductive path and the resistive path by simultaneously making contact with the conductive path and the resistive path.

18. The method of claim 17 further comprising providing an external control element substantially adjacent the contactless tap.

19. The method of claim 17 wherein the sealed channel further comprises:
a backing;
a non-conductive spacer attached to the backing, the spacer including a cutout area forming a window, the window sized to receive the contactless tap and to permit the contactless tap to move through substantially the full length of the conductive path and the resistive path; and
a non-conductive cover attached to the spacer to seal the area defined by the backing, the spacer, and the cover with the contactless tap therein.

20. The method of claim 17 wherein the contactless tap comprises a permanent magnet.

21. The method of claim 18 wherein the external control element comprises a permanent magnet.

22. The method of claim 17 wherein the resistive path has a shape selected from the group consisting of a line, an arc, a semi-circle, a circle, a bent line, and a collection of attached lines.

23. A method of using a contactless potentiometer comprising:
monitoring a potentiometer comprising a sealed channel comprising a conductive path having a first length, a resistive path having a second length, and a magnetically reactive contactless tap; and
causing the contactless tap to move along the first length or the second length.

24. The method of claim 23 further comprising
placing an external control element substantially adjacent the contactless tap in a position outside the sealed channel; and
causing the contactless tap to move along the first length or the second length by moving the external control element.

25. The method of claim 23 wherein the potentiometer is disposed such that the contactless tap reacts to a magnetic field created by an electric current.
